(19) United States
(12) Patent Application Publication
(10) Pub. No.: US 2008/0172335 A1
(43) Pub. Date: Jul. 17, 2008

(54) USER CREDIT RATING SYSTEM TO PROTECT DIGITAL DATA

(76) Inventor: Chi-Chen CHENG, Taipei (TW)

Correspondence Address: SINORICA, LLC, 528 FALLSGROVE DRIVE, ROCKVILLE, MD, 20850, US

(21) Appl. No.: 11/622,003

(22) Filed: Jan. 11, 2007

(51) Int. Cl. H04L 9/00; G06Q 30/00

(52) U.S. Cl. 705/51; 705/38; 705/14

(57) ABSTRACT

A method of protecting digital data by utilizing a credit rating system is disclosed. Users of a download service have credit ratings and credit histories. Initially when a user signs up for a download service, the user's credit rating is set to a predetermined level. As the user continues to use the service their credit rating is affected by their behavior. If unauthorized copies of the user's files appear on the Internet, pier to pier networks, or on physical storage means, the user's credit rating will go down. If the user's credit rating drops to a certain level, the content provider can suspend or terminate the user's account. If the user exhibits good behavior by not illegally sharing files they are rewarded. The reward comprises free downloads, exclusive content, reduced subscription fees, digital cash, or prizes. As a result, digital data is protected and illegal file sharing is prevented.

### BACKGROUND OF THE INVENTION

1. Field of the Invention

The present invention relates to digital data protection. More specifically, the present invention discloses a method of protecting digital data by using a user credit rating system to reduce illegal file downloading and unauthorized data sharing.

2. Description of the Prior Art

The increase in popularity of pier-to-pier networks has resulted in a dramatic rise in illegal file sharing. While one user may have obtained the original file legally, the user can share the file with others on the network. Therefore one original copy can turn into thousands of illegal copies. As a result, media producers, artists, and content providers do not receive fair compensation, revenue, or profit from their products.

Currently, users of pier to pier networks face little or no penalty for their illegal file sharing activities. It is impossible to determine who originally shared the files or digital data. Therefore, the amount of content and the number of files being shared is increasing unchecked.

Several systems have been implemented in order to try to reduce the number of illegal copies of various types of multimedia and software. One system is the use of digital rights management (DRM). DRM is a technique used to control access and usage of digital data. Typically DRM will restrict usage to a single instance of the data or a single device. While DRM works fairly well for content providers the technology is annoying for users.

Additionally, some types of DRM have been successfully defeated by hackers. As a result the digital data can be shared without authorization using popular file sharing tools. This prevents content owners from receiving their deserved profit.

Therefore, there is need for an improved method of protecting digital data that prevents illegal copying and sharing by utilizing a credit rating system that rewards good user behavior and punishes bad user behavior.

### SUMMARY OF THE INVENTION

To achieve these and other advantages and in order to overcome the disadvantages of the conventional method in accordance with the purpose of the invention as embodied and broadly described herein, the present invention provides a method of protecting digital data such as multimedia content by utilizing a user credit rating system.

In the present invention, users have credit ratings and credit histories. Initially when a user signs up for a download service from a content provider, the user's credit rating is set to a predetermined level. As the user continues to use the service their credit rating is affected by their behavior. If the user exhibits good behavior by not illegally sharing files they are rewarded. If unauthorized copies of the user's files appear on the Internet, pier to pier networks, or on physical storage means, the user's credit rating will go down. If the user's credit rating drops to a certain level, the content provider can suspend or terminate the user's account.

In this way, the present invention prevents unauthorized sharing of digital data by promoting and rewarding good user behavior. Users protect their credit rating much like they protect their credit cards. A credit card user would not loan or give their credit card to anyone else for fear that unauthorized purchases would be made thus negatively affecting their credit rating. Similarly, a download service user will not share the digital data with anyone else since the user's credit rating will be affected and they will no longer be able to use the download service.

Additionally, to promote good user behavior the present invention rewards user's that have a very good credit rating or a high ranking. The reward comprises free downloads, reduced or free subscription fees, money, digital cash, prizes or gifts, or other types of rewards.

As a result, the present invention prevents unauthorized sharing of digital data and rewards good user behavior.

The present invention further comprises using a watermark to identify individual users and multimedia content in order to prevent illegal copying of the multimedia content. A digital watermark or electronic fingerprint is embedded in digital data. The watermark identifies the user who downloaded or is going to download the digital data. The content provider or the download service scans the Internet and pier to pier networks for files containing a watermark. When a watermark is detected, the watermark is read and the user who originally downloaded the digital data is identified. If unauthorized copying or sharing of the data is discovered the original user can easily be punished.

In the present invention a content provider supplies multimedia content that is available for download by registered users. The content comprises music, video, games, software, electronic books, documents, or other types of digital data. A user signs up for the service and creates a user account. An initial credit rating is given to the user. Once the user logs into the user account the user can begin downloading the data.

When the data has been successfully downloaded to a user device a watermark is embedded into the data. The watermark comprises a user's account information, a user identifier, a user's real name, a data identifier, a content provider identifier, a device identifier, or a combination of these. Since the user submitted information during the registration process the user can easily be identified. The user provides information such as, for example, user name, real name, address, telephone number, contact information, age, gender, payment method, payment means, passport number, social security number, national identification number, etc.

If an unauthorized copy of the digital data is discovered the watermark identifies the original user who downloaded the data. If the digital data was illegally shared the original user can be punished by lowering their credit rating. The severity can be determined by the number of illegal files being shared, by the monetary value of the content, or by the number of different types of files being shared. If the user's credit rating drops below a threshold the download service can suspend or terminate the user's account.

As a result users protect their digital data and will not share the data in an unauthorized manner. Therefore, piracy of the digital data is prevented.

The method of the present invention is suitable for music or video download services. However, the method can be applied to any type of service that provides downloadable data. Since the method of the present invention prevents unauthorized copying of digital data, content provider's profits increase and the digital data can be provided at a lower cost to users. This has the effect of making the service more popular.

An advantage of the present invention is that users protect their digital data by protecting their credit rating rather than requiring the content provider to try to protect the data once it is out of the content provider's control. The method is much more effective making it easier to control protection of the digital data.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a flowchart illustrating a method of protecting digital data by using a user credit rating system according to an embodiment of the present invention;

FIG. 2 is a flowchart illustrating a method of protecting digital data by utilizing a user credit rating system according to an embodiment of the present invention;

FIG. 3 is a flowchart illustrating a method of protecting digital data by utilizing a user credit rating system according to an embodiment of the present invention;

FIG. 4 is a flowchart illustrating a method of digital data protection by rewarding good user behavior according to an embodiment of the present invention;

FIG. 5 is a flowchart illustrating a method of protecting digital data by utilizing a user ranking system according to an embodiment of the present invention; and

FIG. 6 is a flowchart illustrating a method of protecting digital data by utilizing a user credit rating system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

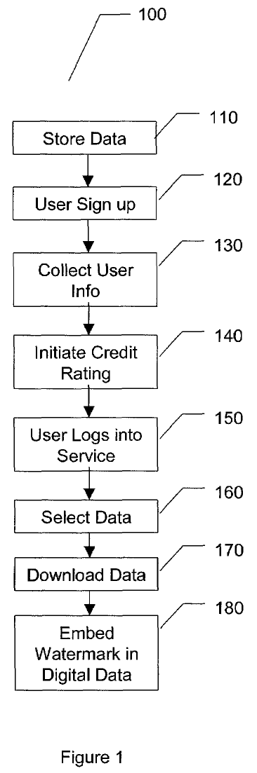

Refer to FIG. 1, which is a flowchart illustrating a method of protecting digital data by using a user credit rating system according to an embodiment of the present invention.

In the method 100 as shown in FIG. 1, a content provider establishes a download service by storing digital data on a server in Step 110. Next, in Step 120 a user signs up for the download service. In Step 130, during registration the user supplies personal information comprising, for example, user name, real name, address, telephone number, contact information, age, gender, payment method, payment means, payment information, password, or other information that can be used to identify the user.

After registration is complete the user is given an initial credit rating associated with their account in Step 140. The default level is predetermined. For example, if various levels of membership are offered, higher levels can be given a higher credit rating.

In order to use the download service the user logs in by supplying their user name and password in Step 150. When the user is logged in the user can browse through the download service or content provider's website and select various files of digital data to download in Step 160. The digital data comprises music, video, games, software, multimedia, or other types of digital data.

In Step 170, the selected digital data is downloaded to the user's electronic device, for example, a computer, notebook computer, PDA, or cellular phone. After the download is complete a watermark or digital fingerprint is embedded into the digital data in Step 180. The watermark comprises data that identifies the user who originally downloaded the digital data. For example, in an embodiment of the present invention the watermark comprises the user name of the user who downloaded the digital data.

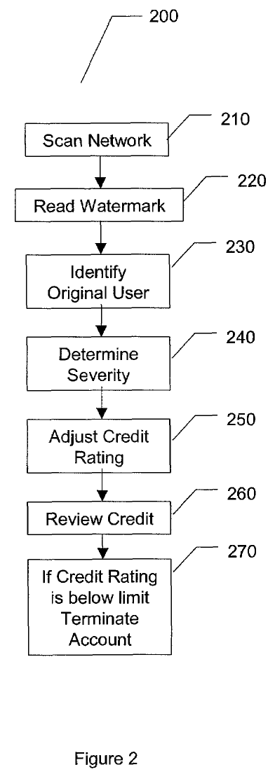

Refer to FIG. 2, which is a flowchart illustrating a method of protecting digital data by utilizing a user credit rating system according to an embodiment of the present invention.

In the method 200 as the content provider continues to offer the download service, the Internet, pier to pier networks, bit torrent networks, or other file sharing networks are routinely scanned for unauthorized copies in Step 210. The files are scanned to detect watermarks. In Step 220, when a watermark is detected the watermark is read and in Step 230 the user who originally downloaded the digital data is identified.

In Step 240, the content provider determines the severity of the illegal action and in Step 250 adjusts the original user's credit rating. In Step 260, the user's credit rating and credit history are reviewed. If the user's credit rating drops to or below an acceptable level, the content provider suspends or terminates the user's account in Step 270. If the user's credit rating is still acceptable the user's account is maintained and the user can continue to use the download service.

Since the digital data comprises the embedded watermark which identifies the user, the user will be extremely cautious with the digital data. A user will not let the digital data get out of their immediate control. For example, a user will not allow the digital data with the watermark to be shared on a file sharing network as this would result in negatively affecting the user's credit rating and could potentially end the user's use of the download service.

Utilizing the method of the present invention users will treat their digital data similar to how they treat their credit cards. A user wouldn't allow their credit card to be used by others as it could destroy their credit. In the same way with the present invention a user won't allow their digital data to be copied and shared by others as the copy will carry their identity. If multiple copies of the digital data appear on a file sharing network the original user faces severe consequences. As a result users are very protective of their digital data.

In other embodiments of the present invention the watermark or digital fingerprint comprises a user's account information, a user identifier, a user's real name, a data identifier, a content provider identifier, a device identifier, or a combination of these.

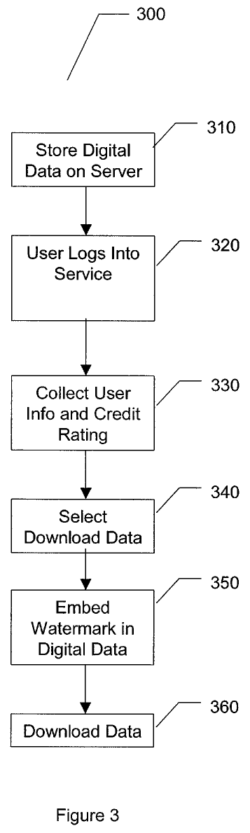

Refer to FIG. 3, which is a flowchart illustrating a method of protecting digital data by utilizing a user credit rating system according to an embodiment of the present invention.

In this embodiment's method 300 the watermark is embedded by the content provider. In Step 310, the content provider provides digital data and stores the data on a server. A registered user logs into the server in Step 320 and the server collects or retrieves the user's account information and credit rating in Step 330. When the registered user selects a digital data file to download in Step 340, the watermark is embedded into the digital data prior to download in Step 350. This watermark is personalized according to the user's information or identification so that each user is uniquely identifiable. Once the watermark is embedded the digital data is downloaded to the user's device in Step 360.

This method provides extreme security for the content provider. The watermark comprises characteristics that identify the user who is downloading the data. Therefore any copies of the digital data can be identified by reading the watermark.

Since the watermark identifies the original downloading user, the user will not allow the digital data to be copied or shared due to the risk of destroying their credit rating. In this way, the method of the present invention efficiently and effectively protects digital data and prevents illegal or unauthorized copying and sharing of the digital data.

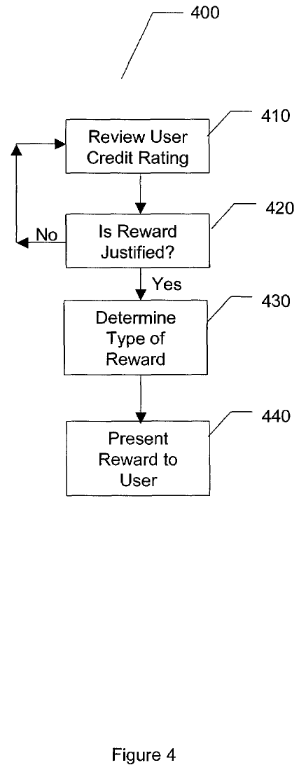

Refer to FIG. 4, which is a flowchart illustrating a method of digital data protection by rewarding good user behavior according to an embodiment of the present invention.

The present invention comprises both negative and positive re-enforcement. In the previous embodiment digital data is protected by punishing bad user behavior such as unauthorized file sharing by using a user credit rating system that lowers a user's credit rating if illegal copies are discovered. In the embodiment illustrated in FIG. 4, the method 400 comprises a user credit rating system that rewards good user behavior.

In Step 410, the content provider reviews a user's credit rating and credit history. The content provider determines if a reward is justified in Step 420. If justified, the content provider determines the size or type of reward in Step 430 and presents the reward to the user in Step 440. If no reward is justified, the content provider continues the credit review process for another user.

The reward comprises, for example, free downloads, exclusive content, reduced or free subscription fees, money, digital cash, prizes or gifts, or other types of rewards. Since the user receives rewards in addition to the download service, the user will continue to exhibit good user behavior. Not only does this result in increased popularity of the service but digital data is also well protected. Users will not share their files with others in an unauthorized manner.

The frequency of the credit review process is determined by the content provider. For example, the process can be performed annually, quarterly, monthly, weekly, etc.

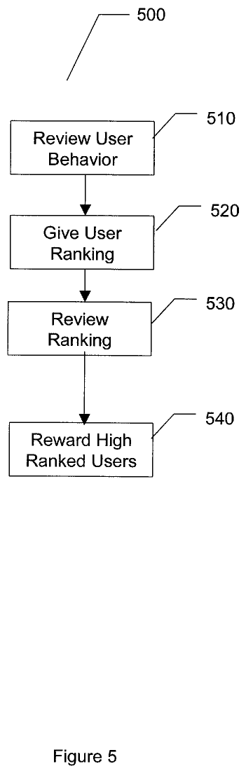

Refer to FIG. 5, which is a flowchart illustrating a method of protecting digital data by utilizing a user ranking system according to an embodiment of the present invention.

As illustrated in FIG. 5, in an embodiment of the present invention the method 500 comprises a user ranking system. In Step 510, the content provider reviews each user behavior. The review process comprises reviewing the user's credit rating, credit history, number of downloads, number of illegally shared files, account history, length of subscription, amount of money paid to the service, account activity, or a combination of these. After reviewing the user's behavior, each user is given a ranking in Step 520. The ranking is then reviewed in Step 530 and high ranked users are rewarded in Step 540.

As a result, user's will try to obtain a high ranking in order to receive a reward by exhibiting good behavior by not illegally sharing files. Additionally, users will utilize the download service more and potentially spend more money. Therefore, the content provider's revenue will increase and the service will become more popular.

The amount, size, or type of reward is determined by the content provider. For example, if a user continually receives a high ranking for a certain amount of time they can be given an unlimited content or free lifetime membership.

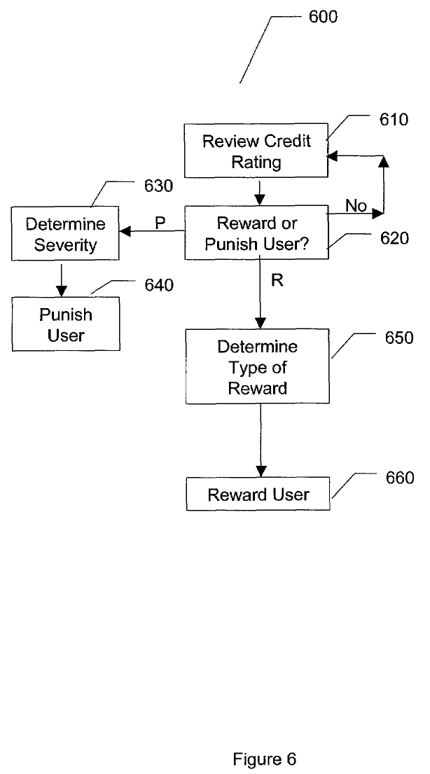

Refer to FIG. 6, which is a flowchart illustrating a method of protecting digital data by utilizing a user credit rating system according to an embodiment of the present invention.

The method 600 as illustrated in FIG. 6 comprises a user credit rating which rewards good user behavior and punishes bad user behavior. In Step 610 a user's credit rating is reviewed. Next, in Step 620 it is determined whether the user should be rewarded or punished. If the user is to be punished the severity is determined in Step 630 and the user is punished in Step 640. The punishment comprises, for example, suspending, terminating, or limiting the user's account.

If the user is to be rewarded, the amount, size, or type of reward is determined in Step 650 and the user is rewarded in Step 660. If no reward or punishment is deserved, another user's credit rating is reviewed.

In another embodiment of the present invention the user's credit rating and credit history are reviewed in order to determine if the user should be punished or rewarded.

While the above description details a content provider performing the actions, obviously the method can be performed by a third party or parts of the method can be separated between several parties. For example, a third party could perform the scanning for illegally shared files and alert the content provider if any unauthorized files are found. In this way the content provider maintains the credit rating system and the third party performs the detective work.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of protecting digital data comprising:
maintaining a credit rating for a user of a download service; and
rewarding or punishing the user according to the credit rating.

2. The method of protecting digital data of claim 1, the credit rating reflecting the user's behavior.

3. The method of protecting digital data of claim 2, where quality of the user's behavior is determined by discovery or non-discovery of unauthorized copies of the digital data.

4. The method of protecting digital data of claim 1, further comprising:
lowering the user's credit rating if unauthorized copies of the digital data are discovered.

5. The method of protecting digital data of claim 1, further comprising:
raising the user's credit rating if no unauthoried copies of the digital data are discovered.

6. The method of protecting digital data of claim 1, further comprising:
ranking users of the download service according to their credit rating; and
rewarding high ranking users.

7. The method of protecting digital data of claim 1, further comprising:
embedding a digital watermark in the digital data, the digital watermark identifying the user; and
reading the digital watermark in digital data shared on a network to identify the user; and
lowering the identified user's credit rating.

8. The method of protecting digital data of claim 1, further comprising:
scanning a network for unauthorized copies of digital data;
lowering the user's credit rating if unauthorized copies are found; and
raising the user's credit rating if no unauthorized copies are found.

9. The method of protecting digital data of claim 1, the rewarding comprising:
presenting the user with free downloads, exclusive content, reduced or free subscription fees, money, digital cash, prizes, gifts, or a combination of these.

10. A method of protecting digital data comprising:
maintaining a credit rating for a user of a download service;
scanning for unauthorized copies of the digital data;
lowering the user's credit rating when unauthorized copies are discovered; and
raising the user's credit rating when no unauthorized copies are discovered.

11. The method of protecting digital data of claim 10, further comprising:
embedding a digital watermark in the digital data which identifies the user.

12. The method of protecting digital data of claim 10, further comprising:
suspending or terminating a user's account the user's credit rating drops to a predetermined level.

13. The method of protecting digital data of claim 10, further comprising:
rewarding the user if the user's credit rating rises to a predetermined level.

14. The method of protecting digital data of claim 10, further comprising:
ranking users of the download service according to each user's credit rating; and
rewarding high ranking users.

15. The method of protecting digital data of claim 10, the rewarding comprising:
presenting the user with free downloads, exclusive content, reduced or free subscription fees, money, digital cash, prizes, gifts, or a combination of these.

16. A method of protecting digital data comprising:
maintaining a credit rating for a user of a download service;
embedding a digital watermark in the digital data, the digital watermark identifying the user;
reading the digital watermark of digital data shared on a network to identify the user; and
lowering the user's credit rating.

17. The method of protecting digital data of claim 16, further comprising:
suspending or terminating a user's account if the user's credit rating drops to a predetermined level.

18. The method of protecting digital data of claim 16, further comprising:
raising the user's credit rating if the digital watermark of the user is not found.

19. The method of protecting digital data of claim 18, further comprising:
rewarding the user if the user's credit rating rises to a predetermined level.

20. The method of protecting digital data of claim 19, the rewarding comprising:
presenting the user with free downloads, exclusive content, reduced or free subscription fees, money, digital cash, prizes, gifts, or a combination of these.
